(19) United States
(12) Patent Application Publication
(10) Pub. No.: US 2010/0035081 A1
(43) Pub. Date: Feb. 11, 2010

(54) METHOD FOR THE PRODUCTION OF THIN LAYERS OF METAL-CERAMIC COMPOSITE MATERIALS

(75) Inventors: Rolf Clasen, St. Ingbert (DE); Mohammadreza Nejati, Hauterive (CH)

Correspondence Address: BROOKS KUSHMAN P.C., 1000 TOWN CENTER, TWENTY-SECOND FLOOR, SOUTHFIELD, MI, 48075, US

(73) Assignee: DRITTE PATENTPORTFOLIO BETEILIGUNGSGESELLSCHAFT MB, Schonefeld, Waltersdorf (DE)

(21) Appl. No.: 12/513,902

(22) PCT Filed: Nov. 12, 2007
(86) PCT No.: PCT/DE2007/002039

§ 371 Date: Jun. 19, 2009

(30) Foreign Application Priority Data
Nov. 10, 2006 (DE) 10 2006 053 361.5

(51) Int. Cl. B32B 15/01; B05D 3/02

(52) U.S. Cl. 428/650; 427/380; 428/655

(57) ABSTRACT

Selective solar absorbers are prepared by coating a reflector with a thin cermet layer prepared by depositing and subsequently sintering at least one cermet layer precursor which is an aqueous or alcoholic dispersion of ceramic nanoparticles, the dispersion also containing dissolved metal ions corresponding to the desired metal in the cermet. Sintering in H₂ or an inert atmosphere reduces the metal ions to elemental metal particles.

This invention is directed to a method for the production of thin layers of metal-ceramic composite materials which contain metallic nanoparticles, and to the use of said method.

In high-efficiency solar thermal collectors, almost the entire solar spectrum from the surface of the solar absorber is converted to thermal energy. The absorber surface and pipes connected thereto emit heat to a heat carrier fluid such as water which flows through said pipes.

The absorber surface is the most important component part of solar thermal collectors. It is possible to achieve a high photothermal conversion yield for such collectors by the use of spectrally selective absorbers. Such surfaces exhibit good absorption to radiation in the terrestrial solar spectrum while strongly reflecting thermal wavelengths, i.e. they radiate only a small amount of the absorbed heat. Since there is no natural material exhibiting said surface properties, selectivity has to be produced with special coatings.

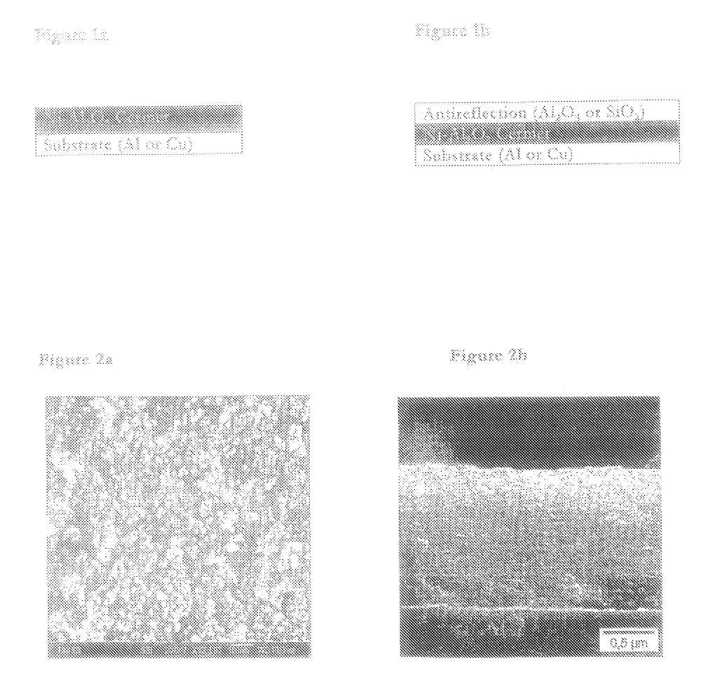

Normally, the effect of spectral selectivity of an absorber may be obtained by an absorber-reflector tandem. An absorber layer having low reflexion (high solar absorption) for wavelengths <2.5 μm while being transparent for thermal wavelengths in the IR range is deposited onto a metallic surface having high reflection (low thermal emissivity) for wavelengths >2.5 μm (FIG. 1). Hence, the absorber layer ensures maximum solar absorption with minimum influence on the thermal emissivity which, in its turn, is dominated by the reflector layer or the metallic substrate. Numerous metal-ceramic composite layers on a metallic substrate exhibit this optical characteristic.

Simple commercially available selective solar absorbers are produced by means of electroplating, anodizing, and chemical oxidation techniques. The most commonly used, electrochemically produced, selective photothermal absorber layers are black chromium, black zinc, copper oxide, black cobalt, black nickel, iron oxide, and pigmented alumina.

Such absorbers exhibit a solar absorptivity of 0.9 and thermal emissivity of from 0.1 to 0.3 and are usually temperature-stable up to temperatures of from 425 to 500° Kelvin. These production methods require toxic acid baths and complicated combinations of metal salts. Moreover, the waste products from said manufacturing method are toxic, ecologically harmful, and their management (disposal) gives rise to problems.

Moreover, with these methods an exact matching of the optical properties of the absorber with the desired property is either very difficult or even impossible in some cases.

For about two decades, thin films or layers of metal-ceramic composite materials have been thoroughly investigated on account of their suitable and adaptable optical properties with a view to their suitability as selective solar absorbers.

Metal-ceramic composite materials, also called cermet, comprise a ceramic matrix having metallic nanoparticles dispersed therein. Due to the rather high IR transparency and simultaneous high solar absorption of many cermet layers they are predestined for use as selective absorbers. Hence, the use of such cermet layers as absorbers is widely accepted. Furthermore, such coating layers also exhibit long-term stability under varying thermal conditions.

Optical properties of a coating from a composite nano-material may readily be influenced by the layer thickness, the volume fraction of the metallic phase, the geometry and the particle size. Also, the distribution characteristic of the conductive particles may decisively affect the normalized refractive index of the cermet layers. For instance, a stepwise increase in the concentration of metallic particles from the air-cermet interface up to the substrate-cermet interface will lead to a higher absorptivity due to a reduction of the surface reflection.

Deposition via sputter techniques is a very clean process that does not require chemical baths and harmful acids. This deposition method may lead to high-quality optical coating layers with controlled layer thickness from high-purity target materials. Various selective metal-dielectric coatings such as SS-C, SS-AIN (SS=stainless steel), Al—N and TiNOₓ have been produced commercially by the use of cylinder-type or rolling-type sputter techniques.

Problems occurring in such cases are that the sputtering technique is comparatively troublesome and expensive because high-tech voltage sources and large vacuum chambers or clean-room conditions, respectively, are required as well as a precise controlling and regulating system allowing for the adjustment of the gas composition, the layer thickness, and the pressure conditions. In all, the energy expenditure required for the technique is also high.

Considering the current conditions in the solar market, which is in its initial phase of development where the absorber layers are still the most expensive component part of a collector, sputtering is currently not a means for the economic production of less expensive solar thermal collectors.

In contrast to sputtered layers, solar absorber paints represent a less expensive variant, however they exhibit a very high thermal emissivity of 80 to 90% caused by modes of vibration of the incorporated organic polymer binders, and they also suffer from low long-term stability. The stability of such paints has been improved by using organically modified silicone resins. So far, however, the paint-based absorbers are normally found in the group of non-selective or moderately selective absorbers due to their poor optical properties.

A low-cost, mechanically produced solar absorber was obtained by combining a graphite layer with a mechanically polished substrate. Such coating layers are highly sensitive in respect of the polishing parameters and exhibit solar absorption around 0.9 and thermal emission up to 0.22.

DE 196 20 645 C2 describes a sol-gel technique in which conductive particles are introduced in the starting sol or in the gel to be formed while it is not yet highly viscous. In this method the conductive particles must be atomized down to less than 70 nm under an inert gas atmosphere under high pressure (10 Pa up to 1000 Pa). Larger particles are subsequently separated by screening methods. In this method the metallic particles have to be coated with a dielectric layer as protection against chemical influences and diffusion. The very large reactive surface of the produced metallic nanoparticles leads to problems due to chemical oxidation of particles, which must be prevented. Moreover, surface treatment, particle atomization and screening are expensive additional steps leading to higher costs for this production method.

Previous investigations are mainly confined to the microstructure and the improvement of mechanical properties of metal-ceramic nanocomposites by means of modifications concerning the distribution of the nanoparticles and their plasticity. It was mainly Sekino et al. who investigated the mechanical properties of various metal-ceramic nanocomposites by using conventional powder-metallurgical methods, the reduction and subsequent sintering of ceramic and metal-oxidic powders such as W—Al₂O₃ (T. Sekino, A. Nakahira and K. Niihara, Relationship between microstructure and high temperature mechanical properties for Al2O3/W nanocomposites. Transactions of the materials research society of Japan 16B (1994) 1513-1516, and T. Sekino, A. Nakahira, M. Nawa and K. Niihara, Fabrication of Al2O3/W Nanocomposite. J. Japan Soc. of Powd. and Powd. Metal 38 (1991) 326-330) or by chemical methods such as sol-gel for the production of metal-ceramic composite powders like Ni—Al₂O₃ (T. Sekino, T. Nakajima, S. Ueda and K. Niihara, Reduction and sintering of a nickel-dispersed-alumina composite and its properties. J. Am. Ceram. Soc. 80 (1997) 1139-1148, and T. Sekino, T. Nakajima and K. Niihara, Mechanical and magnetic properties of nickel-dispersed alumina-based nanocomposite. Mater. Lett. 29 (1996) 165-169). These methods were used for the production of bulk samples which have a metal content of from 5 to 30% in the composite with metal particles sizes of about 40-150 nm.

In the last few decades, various spectrally selective Ni—Al₂O₃ composite layers were produced by means of different methods. The layers were produced at bench-scale by planar RF magnetron sputtering using hot-pressed Ni—Al₂O₃ targets. With this method it is not easy to achieve a change of nickel content in the composite layer, and additional Ni pellets had to be arranged in a special geometry on the composite target so as to obtain higher volume fractions of the metal. Using a 78 nm SiO₂ anti-reflection layer, values of about 0.94 for solar absorption and of 0.07 for thermal emission were thus achieved.

It has also been known to anodize aluminium substrates by means of phosphoric acid and subsequently to colorize the anodized aluminium by means of a.c. electrolysis in a NiSO₄ impregnating bath. This achieves solar absorption of 0.93-0.96 and thermal emissivity of 0.1-0.2. Using the same manufacturing method and investigating the effects of various impregnating parameters on the optical properties of the layers resulted in solar absorptivities of more than 0.9 and thermal emissivity of 0.14.

Even though pigmented alumina coatings are commercially used in solar collectors they are normally not regarded as being particularly selective.

Based on the previous works concerning sol-gel-based antireflection layers and C—SiO₂ composite layers, Ni-aluminum layers were produced from an Ni—Al₂I₃ sol which achieved a solar absorption of 0.83 and thermal emission of 0.03 with a cermet layer comprising a nickel content of 65%.

This invention is based on the object of providing a method for the production of thin layers of metal-ceramic composite materials which is very simple, reliable and inexpensive, which yields layers having good spectral selectivity that are resistant to atmospheric moisture and high temperatures, and which method may be used with various materials.

In accordance with the present invention said object is solved by a method comprising the features of claim 1. The dependent claims recite advantageous embodiments. A preferred use of the method is the coating of cermet-based selective solar absorbers.

With the method according to the invention one or more thin cermet layers having a thickness of from 50 to 2.000 nm are deposited on the substrate by immersing metallic substrates into a stabilised aqueous or organic suspension. The suspension is composed of an alcoholic or aqueous solution in which ceramic nanoparticles having a particle size of less than 30 nm are dispersed. The solution contains the metallic portion of the cermet in the form of metal ions.

Depending on the type of solvent (water or alcohol) the suspension is stabilized by either electrostatic or steric stabilization. In order to eliminate agglomerates or aggregates, the suspension is well dispersed by means of mechanical and ultrasonic dispersing techniques.

The materials required therefor may be readily obtained at comparatively low cost. It is advantageous that toxic acid baths, which must be disposed of correspondingly, are not required. Also, the present method allows setting of the metallic and ceramic bulk factor in the thin layer or composite, respectively, simply by adjusting the concentration of the metal ions dissolved in the solution.

The prepared suspension may be applied onto a reflector substrate by spraying or immersion. This approach is also suitable for mass production when coating large surfaces. Apart from the low requirements in respect of the plant and the process control, a further advantage of the present method resides in the fact that coating of virtually any kind of surface and not only planar surfaces is possible.

As the substrate for the coating method of the present invention, any substrate may be used that is suitable for solar absorbers. Preferably, the substrate is made of a metal or metal alloy of low emissivity, for example copper or aluminium. When glass pipes or glass substrates are used, the glass may initially be silver-coated by means of Tollens' reagent in order to achieve a similar effect. Subsequent to drying, the cermet layer may be applied.

In accordance with the embodiment of claim 8 the metallic portion of the cermet may be formed from the group comprising Cu, Ni, Fe, Cr, Zn, Ti, Ag, Co, Al, Pd, and Zr in the form of corresponding metal salts.

With the embodiment according to claim 9, the ceramic portion may be selected from nanopowders of the group comprising Al₂O₃, AlN, SiO₂, TiO₂, ZrO₂, Y₂O₃, WO₃, Ta₂O₅, V₂O₅, Nb₂O₅, CeO₂ or a mixture of two or three different nanopowders.

In the embodiment according to claim 10, several layers with different metal content (from low to high) are successively applied so as to reduce reflection losses at the surface. Advantageously, this allows a particularly good adjustment of the optical properties of the coating as a whole. The individual layers may be applied successively whenever the previously applied layer has dried.

In contrast to the likewise known sol-gel systems it is advantageous that in the present invention metallic alkoxides, which are rather expensive, need not be used. Moreover, there are no complicated chemical reactions which would have to be controlled exactly with a view to precise adjustment of the layers and their properties. This applies especially also to the hydrolysis process taking place in the sol-gel systems. A further problem with the sol-gel systems is the short storage time and premature formation of networks which grows with time and complicates processing accordingly. Likewise, problems are avoided which occur in the sol-gel systems due to the formation of cracks in thin layers while drying. Another advantage of the liquid powder suspensions as compared to the sol-gel systems is that the liquid powder suspensions are more stable and exhibit a longer shelf life. This holds especially when such liquid powder suspensions are stirred. Even when stirring is discontinued the stabilized suspension may be used for some hours. Even aged suspensions may be re-dispersed. Below, an embodiment of the invention will be described in detail.

Below, the invention will be explained in detail with reference to an embodiment thereof.

### EMBODIMENT

### Ni—Al₂O₃ Cermet Solar Absorber

Copper and aluminium substrates are used as starting materials. To eliminate negative effects of the surface quality on the solar absorption, the surfaces are subjected to fine-polishing prior to coating. Moreover, removal of the surface roughness allows uniform application of the layers with no undesirable attachments on unwanted uneven sites.

Subsequently, the substrates are cleaned with ethanol and distilled water.

For preparing suspensions having a solids content of from 2 to 20% by weight, a metal salt such as, in the instant case, nickel salt (the amount depends on the desired metallic portion in the layer), is initially dissolved in 200 ml of distilled water in a beaker. Then, Al₂O₃ nanopowder having an average particle size of 5 to 30 nm is added. The mixture is allowed to be mechanically dispersed for 30 minutes at a controlled temperature (cooling) and high rotational speed. To avoid sedimentation and agglomeration, the entire suspension is stabilized either electrostatically or electrosterically (depending on the solvent). Ultrasonic dispersion may additionally be used so as to obtain a finer particle size distribution.

Preferably, wetting and adhesive agents are added to the suspension so as to improve wetting of the substrate and film adhesion.

After dispersing for 30 minutes the solution is filtrated with sub-micron filters.

The substrates are immersed into the prepared suspension. The component to be coated should remain immersed for several seconds so as to obtain a state of equilibrium between the substrate and the solution. Subsequently, the substrate is withdrawn from the bath under controlled conditions and at constant speed. Following removal of the component to be coated from the bath, the component is dried in a drying cabinet. Thereafter, the dried samples are subjected to thermal treatment in order to achieve a corresponding hardness of the coating. Such a thermal treatment may be performed in an oven at about 500 K to 1.000 K. Sintering is performed under a pure hydrogen or inert gas atmosphere, thus reducing oxide phases of nickel and avoiding any oxidation of the substrate.

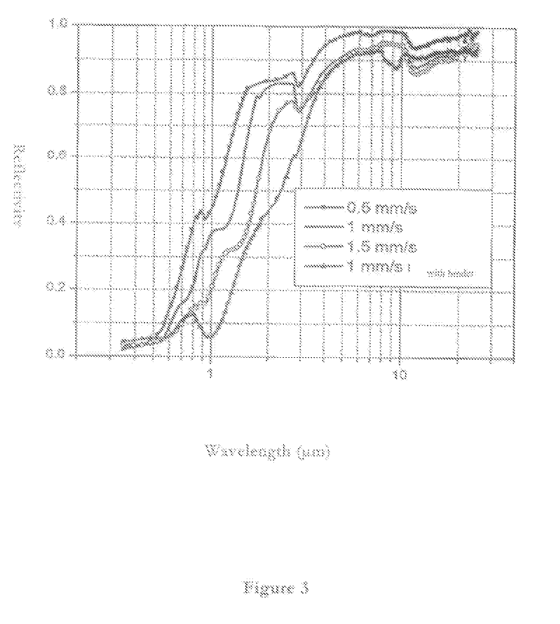

The embodiment of the invention is explained with reference to FIGS. 1 to 3. FIG. 1 describes an absorber-reflector tandem for an Ni—Al₂O₃ absorber either including (FIG. 1b) or not including an antireflecting coating (FIG. 1a). FIG. 2 shows 2 micrographs of the surface (FIG. 2a) and the cross-section (FIG. 2b) of a deposited Ni—Al₂O₃ layer which was deposited by the method according to claim 1.

By adjusting the Ni content in the cermet layer to 20% by weight and by depositing individual cermet layers with varying layer thicknesses (which are obtained by altering the drawing speed) on a polished Al substrate one will obtain the selectivity shown in FIG. 3. The sample which contains adhesive agent demonstrates the absorptivity of 0.87 and a thermal emissivity of 0.08. The optical properties may be improved further by a final antireflection layer.

FIG. 3 shows the reflectivity of Ni—Al₂O₃ absorbers with no antireflection layer, which contain 20% by weight of Ni and were deposited by means of immersion techniques at different drawing speeds (different layer thicknesses) on an aluminium substrate. The influence of adhesive agent on the reflection characteristic is additionally shown.

1.-12. (canceled)

13. A method for the production of thin layers of metal-ceramic composite materials containing metallic nanoparticles, comprising:
a) supplying an aqueous or alcoholic solution in which the metallic portion of the cermet is present in the form of dissolved metal ions,
b) dispersing ceramic nanoparticles into the solution to form a ceramic particle suspension,
c) stabilizing the ceramic nanoparticles sterically or electrostatically,
d) removing agglomerated solid particles contained in the suspension by mechanical or ultrasonic dispersing techniques while being cooled,
e) optionally adding inorganic wetting agents and adhesive agents to improve wetting of the substrate and adhesion of a layer to the substrate,
f) applying the suspension onto a reflector substrate, and drying the suspension to form a coated substrate, and
g) subsequent to drying, sintering the coated substrate in an H₂ or inert gas atmosphere, forming metallic particles.

14. The method of claim 13, wherein the metal particle size is less than 40 nm.

15. The method of claim 13, wherein individual layers having a layer thickness of about 50 nm to about 2 μm are produced.

16. The method of claim 13, wherein sintering is effected at temperatures of up to 1,000° K.

17. The method of claim 13, wherein the substrate comprises a reflector metal or a metal alloy with low emissivity.

18. The method of claim 17, wherein the reflector metal is copper or aluminum.

19. The method of claim 13, wherein a glass substrate is initially coated with silver and is coated with said cermet.

20. The method of claim 13, wherein the relative metallic and ceramic loadings in the thin layer or the composite material are adjusted by altering the metal ion concentration in the solution.

21. The method of claim 13, wherein the metallic portion of the cermet comprises one or more metals selected from the group consisting of Cu, Ni, Fe, Cr, Zn, Ti, Ag, Co, Al, Pd, and Zr, supplied in the form of corresponding metal salts in the solution of step a).

22. The method of claim 13, wherein the ceramic portion of the cermet comprises nanopowders of one or more ceramics selected from the group consisting of Al₂O₃, AlN, SiO₂, TiO₂, ZrO₂, Y₂O₃, WO₃, Ta₂O₅, V₂O₅, Nb₂O₅, and CeO₂.

23. The method of claim 13, wherein a plurality of cermet layers are successively applied, the individual layers differing with respect to their metal content, and in which an antireflection layer is deposited over the cermet layers.

24. The method of claim 23, wherein an antireflection layer comprises a diluted stabilized ceramic suspension having no metallic portion, which is sintered.

25. A selective solar absorber comprising a substrate coated with a cermet by the method of claim 13.

26. A selective solar absorber comprising a substrate coated with a cermet by the method of claim 23.
